(19) United States
(12) Patent Application Publication
(10) Pub. No.: US 2024/0153018 A1
(43) Pub. Date: May 9, 2024

(54) PLANNING ASSISTANCE SYSTEM, PLANNING ASSISTANCE METHOD, AND RECORDING MEDIUM

(71) Applicant: NEC Corporation, Minato-ku, Tokyo (JP)

(72) Inventor: Aiko Yamatani, Tokyo (JP)

(73) Assignee: NEC Corporation, Minato-ku, Tokyo (JP)

(21) Appl. No.: 18/281,204

(22) PCT Filed: Mar. 15, 2021
(86) PCT No.: PCT/JP2021/010357

§ 371 Date: Sep. 8, 2023

(51) Int. Cl. G06Q 50/14; G06Q 50/00

(52) U.S. Cl. CPC G06Q 50/14; G06Q 50/01

(57) ABSTRACT

A planning assistance system according to an aspect of the present disclosure includes at least one memory configured to store instructions; and at least one processor configured to execute the instructions to: receive a comment of each of users for each of a plurality of events included in a travel plan; and cause a display to display the received comment in association with each of the events.

### TECHNICAL FIELD

The present disclosure relates to a planning assistance system and the like.

### BACKGROUND ART

When a plurality of people travels together, it is desirable to create a travel itinerary that respects each person's opinion. For example, when creating a travel itinerary, each person proposes a tourist spot of interest and determines a tourist spot to visit and the like.

PTL 1 discloses an itinerary planning assistance program that receives registration of an itinerary plan including a plurality of pieces of spot information. The program according to PTL 1 displays a message related to an itinerary plan exchanged with a plurality of members.

As a technique related to the present disclosure, PTL 2 discloses a device that discloses a tourist spot to users and friends who participate in a trip, accepts voting for a tourist spot, and generates travel itinerary information via a plurality of tourist spots based on a voting result. In PTL 2, a user uses a server that provides a social network service to disclose, browse, and exchange messages with other users.

### CITATION LIST

### Patent Literature

PTL 1: WO 2017/119071 A

PTL 2: JP 2014-092876 A

### SUMMARY OF INVENTION

### Technical Problem

In PTL 1, when a message is transmitted for an itinerary in which a plurality of spots is visited, it is not clear which spot the message is about. PTL 2 does not disclose how to exchange a message with another user accompanying in the travel.

That is, in the techniques of PTL 1 and PTL 2, it is difficult for the user to present an opinion for each of events such as movement, visit to a certain place, and experience in the itinerary being planned by the user.

An object of the present disclosure is to provide a planning assistance system and the like that enable each user to easily comment on each event in a case where a plurality of users edits a travel plan including a plurality of events while consulting with each other.

### Solution to Problem

A planning assistance system according to the present disclosure includes a comment reception means that receives a comment of each of users for each of a plurality of events included in a travel plan, and a display control means that causes a display means to display the received comment in association with each of the events.

A planning assistance method according to the present disclosure includes receiving a comment of each of users for each of a plurality of events included in a travel plan, and causing a display means to display the received comment in association with each of the events.

A recording medium according to the present disclosure non-transiently records a planning assistance program for causing a computer to execute a process of receiving a comment of each of users for each of a plurality of events included in a travel plan, and a process of causing a display means to display the received comment in association with each of the events.

A program according to the present disclosure causes a user terminal to execute a process of receiving a comment of each of users from an information processing apparatus that receives the comment of each of users for each of a plurality of events included in a travel plan and associates the received comment with each of the events, a process of displaying the received travel plan, and a process of transmitting comments of the users input for the event in the user terminal to the information processing device.

### Advantageous Effects of Invention

According to the present disclosure, a user can easily comment on a travel plan including a plurality of events.

### BRIEF DESCRIPTION OF DRAWINGS

FIG. 1 is a block diagram illustrating a configuration of a planning assistance system 110 according to a first example embodiment.

FIG. 2 is a sequence diagram for explaining an operation example of the planning assistance system 110.

FIG. 3 is a diagram illustrating an example of a display screen of a travel plan displayed on a user terminal 20.

FIG. 4 is a diagram illustrating an example of the display screen of the travel plan including comments.

FIG. 5 is a block diagram illustrating a configuration of a planning assistance system 120 according to a second example embodiment.

FIG. 6 is a sequence diagram illustrating an operation example of the planning assistance system 120 according to the second example embodiment.

FIG. 7 is a diagram illustrating another example of a display screen of a travel plan.

FIG. 8 is a diagram illustrating an example of a display screen of the travel plan.

FIG. 9 is a diagram illustrating a display screen of another example of a reaction of a user to a comment.

FIG. 10 is a diagram illustrating a display screen of another example of reactions of users to a comment.

FIG. 11 is a block diagram illustrating a configuration of a planning assistance system 100 according to a third example embodiment.

FIG. 12 is a flowchart illustrating an operation example of the planning assistance system 100 according to the third example embodiment.

FIG. 13 is a block diagram illustrating an example of a hardware configuration of a computer 500.

### EXAMPLE EMBODIMENT

Hereinafter, a planning assistance system, a planning assistance method, a planning assistance system, and a planning assistance program, which are aspects of an example embodiment of the present disclosure, will be described with reference to the drawings. In the present disclosure, an itinerary is a travel plan including a plurality of events. The itinerary is shared among a plurality of users. The itinerary shared among the plurality of users is also referred to as a travel brochure. One event may be performed during a predetermined time width or may be performed at a certain time.

### First Example Embodiment

(Configuration)

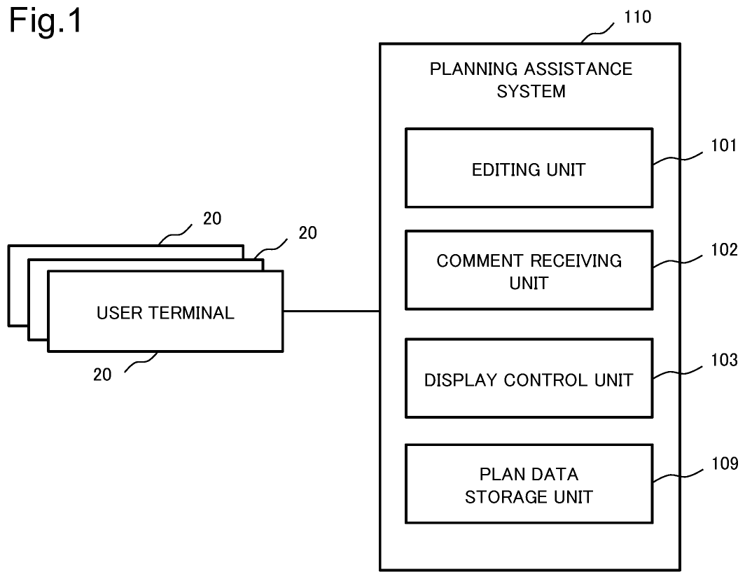

FIG. 1 is a block diagram illustrating a configuration of a planning assistance system 110 according to a first example embodiment. The planning assistance system 110 communicates with a plurality of user terminals 20 via a network. The planning assistance system 110 generates the travel plan and distributes the plan to a plurality of user terminals 20.

The user terminal 20 may be a mobile terminal, a smartphone, a tablet, a personal computer, or other terminals. The user terminal 20 is used by a plurality of users participating in a travel to browse and edit a plan and to browse and edit a comment on an event. The user terminal 20 is an example embodiment of a display means.

The planning assistance system 110 includes an editing unit 101, a comment receiving unit 102, a display control unit 103, and a plan data storage unit 109.

The editing unit 101 stores a new plan in the plan data storage unit 109. The editing unit 101 registers one or more events in the plan. For example, the editing unit 101 registers an event based on an event registration request received from the user terminal 20. Each event includes a movement during a travel, visiting a place, having an experience, or the like. The editing unit 101 may further register an execution date of the event and an execution time of the event. The execution time of the event may be any of a start time, an end time, and a duration of the event.

The comment receiving unit 102 receives a comment of each user for each event. The comment receiving unit 102 stores the received comment in the plan data storage unit 109.

For example, the display control unit 103 causes the travel plan to be displayed based on a browsing request from the user terminal 20. The display control unit 103 may cause the user terminal 20 to display any one of the start time, the end time, and the duration of the event in association with the event.

Further, the display control unit 103 causes the comment received by the comment receiving unit 102 to be displayed in association with each event. For example, the display control unit 103 may cause user identification information such as a user name or a profile image to be displayed together with the comment to display which user the comment is made by.

The user terminal 20 includes a storage unit and a processing unit. The storage unit stores, for example, data used for processing of the user terminal 20. The processing unit may implement the function of the user terminal 20 by executing the application program stored in the storage unit. In this case, the storage unit stores, for example, the downloaded application program. Alternatively, the processing unit may implement the following functions of the user terminal 20 by causing a browser to display a web page distributed through the Internet.

The processing unit of the user terminal 20 causes a display screen displayed by the display control unit 103 to be displayed on any display. The user participating in the travel browses the event using the user terminal 20. The user terminal 20 receives an input of a comment on the event from the user. The user terminal 20 transmits the comment of the user input for the event to the planning assistance system 110. The user terminal 20 displays the travel plan and the comment on each event on the same screen.

The processing unit of the user terminal 20 may execute processing of controlling display and non-display of the comment in response to the input of the user. The processing unit of the user terminal 20 may control the display/non-display of the comment on the event for each event.

In the first example embodiment, the user participating in the travel may be distinguished into a manager of the itinerary and a general participant. The manager of the itinerary has authority to edit the itinerary. Specifically, for example, the manager can add, change, and delete events. The manager can edit the execution time of the event or the order of the event. The manager may have authority to delete comments of other users. For example, if the manager considers that an opinion of another user for the event has been taken into consideration, the manager deletes the comment.

A general participant can view the itinerary but does not have authority to edit the itinerary. By setting the manager, it is possible to prevent confusion with the itinerary created. The manager can summarize opinions of respective participants.

In the following description, the user terminal 20 of the manager is also referred to as a manager terminal, and the user terminal 20 of a general participant is also referred to as a participant terminal. However, the participant may be given the authority of the manager later, and the authority of the manager may be removed. All the participants may have the authority of the manager.

(Operation)

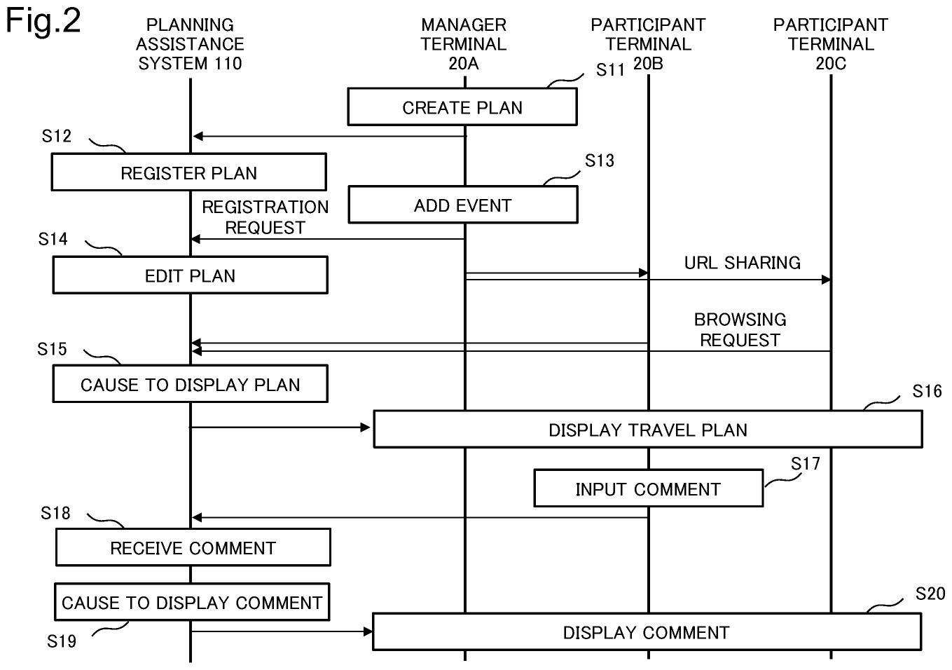

FIG. 2 is a sequence diagram illustrating an operation example of the planning assistance system 110. Description will be made assuming that a manager A of an itinerary uses a manager terminal 20A, a participant B uses a participant terminal 20B, and a participant C uses a participant terminal 20C. The manager terminal 20A and the participant terminals 20B and 20C are also collectively referred to as a user terminal 20.

The manager terminal 20A first creates a new plan (step S11). For example, the manager terminal 20A may set the title, the number of days, and the date in the new plan. The manager terminal 20A transmits the created plan to the planning assistance system 110.

The editing unit 101 registers the plan created by the manager terminal 20A in the plan data storage unit 109 (step S12).

Further, the manager terminal 20A adds one or more events to the plan based on the input of the manager A of the itinerary (step S13). The manager terminal 20A receives an input of an event including at least one of a visit to a certain place, a certain experience, or movement between places. For example, as the event, any characters representing the event may be input, or latitude and longitude representing a place in the event may be input. As in the existing technique, a spot stored in advance by the planning assistance system 110 may be selected. The manager terminal 20A may receive an input of the execution time of the event together with the event. The manager terminal 20A transmits an event registration request to the planning assistance system 110 based on the input.

The editing unit 101 of the planning assistance system 110 edits the plan based on the event registration request (step S14). Specifically, the editing unit 101 additionally registers one or more events in the plan stored in the plan data storage unit 109. The display control unit 103 of the planning assistance system 110 causes the manager terminal 20A to display the generated travel plan on the manager terminal 20A (step S15). For example, the manager A uses the manager terminal 20A to share a uniform resource locator (URL) for accessing the travel plan with the participants of the travel to the participant terminals 20B and 20C by any method. The participant terminals 20B and 20C transmit a browsing request of the travel plan to the planning assistance system 110 based on the URL.

The display control unit 103 of the planning assistance system 110 causes the participant terminals 20B and 20C to display the travel plan based on the browsing request (step S15).

The user terminal 20 displays the travel plan including one or more events (step S16).

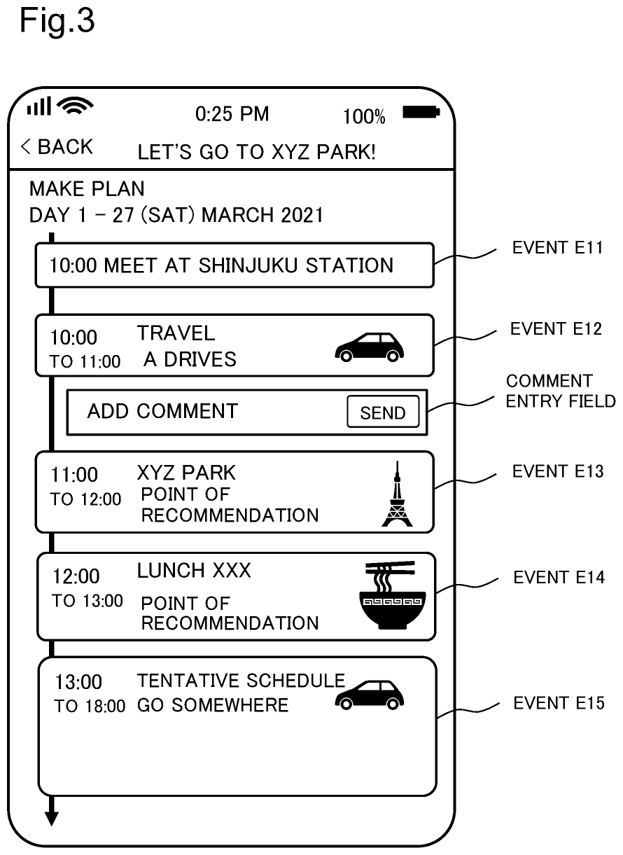

FIG. 3 is a diagram illustrating an example of a display screen of the travel plan displayed on each user terminal 20 (the manager terminal 20A and the participant terminals 20B and 20C). In FIG. 3, a description will be given assuming that the user terminal 20 is a smartphone. The screen of FIG. 3 displays five events (events E11 to E15). In FIG. 3, execution times of the five events are separated.

For example, the processing unit may cause a comment entry field or a comment to be displayed when the display area of each event is tapped. The processing unit may stop the display of the comment entry field and the comment when the display area of the event is tapped again.

Returning to FIG. 2, for example, the participant terminal 20B receives an input of a comment (step S17). Specifically, in FIG. 3, the participant B causes display of the comment entry field of an event for which a comment is desired to be made, inputs the comment, and presses a send button. The participant terminal 20B transmits the comment to the planning assistance system 110.

The comment receiving unit 102 of the planning assistance system 110 receives the received comment (step S18). The comment receiving unit 102 may further receive a comment from another participant C or the manager A. The comment receiving unit 102 stores the received comment in the plan data storage unit 109.

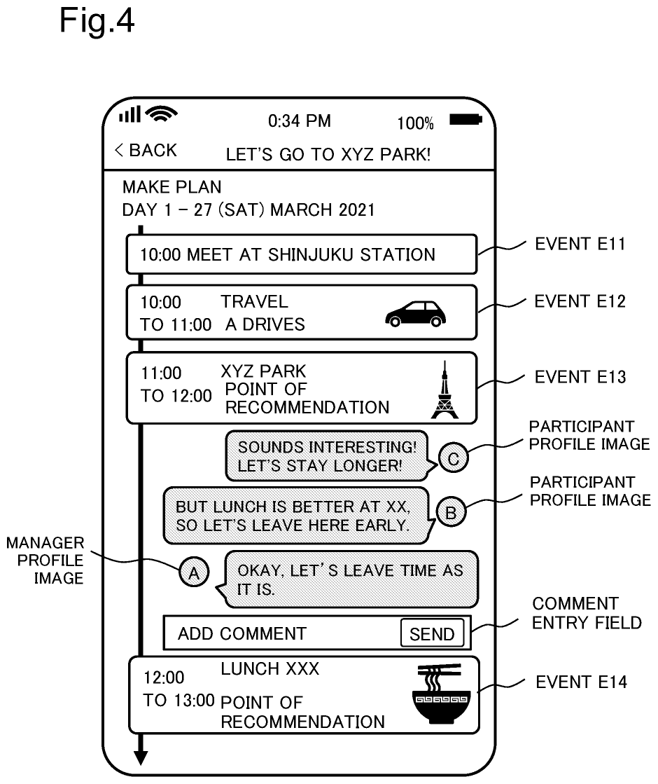

The display control unit 103 causes each user terminal 20 to display a comment for each event (step S19). The processing unit of the user terminal 20 causes the comment to be displayed (step S20). FIG. 4 is a diagram illustrating an example of a display screen of the travel plan including a comment. In FIG. 4, the participants B and C and the manager A make comments on the event E13. For example, the processing unit of the user terminal 20 may cause a profile image of the user having manager authority to be displayed on the left side and may cause a profile image of a user of a general participant to be displayed on the left side. The processing unit may cause a comment to be displayed in association with the profile image.

In FIG. 4, the participant C comments that the participant C desires to increase the duration of the event E13. The participant B desires not to increase the duration. The manager A summarizes the opinions of the participants B and C and comments not to change the time.

The manager A may summarize the opinions of the participants B and C and edit the event and the execution time of the event. For example, the manager A may add, delete, or change an event.

### Effects

According to the first example embodiment, when a plurality of users shares a travel plan including a plurality of events and edits the plan while consulting with each other, each user can easily comment on each of the events. The reason is that the comment receiving unit 102 of the planning assistance system 110 receives the comment of each user for each of the plurality of events included in the travel plan. Further, this is because the display control unit 103 causes the user terminal 20 to display the received comment in association with each event.

When the comment is displayed in association with each event, the displayed comment is not confused even if the comment is input for another event immediately after the comment is input for one event. Therefore, the user can easily present an opinion to each event.

The manager can efficiently aggregate the comments on each event and edit the event in consideration of the comments of other users.

### Second Example Embodiment

(Configuration)

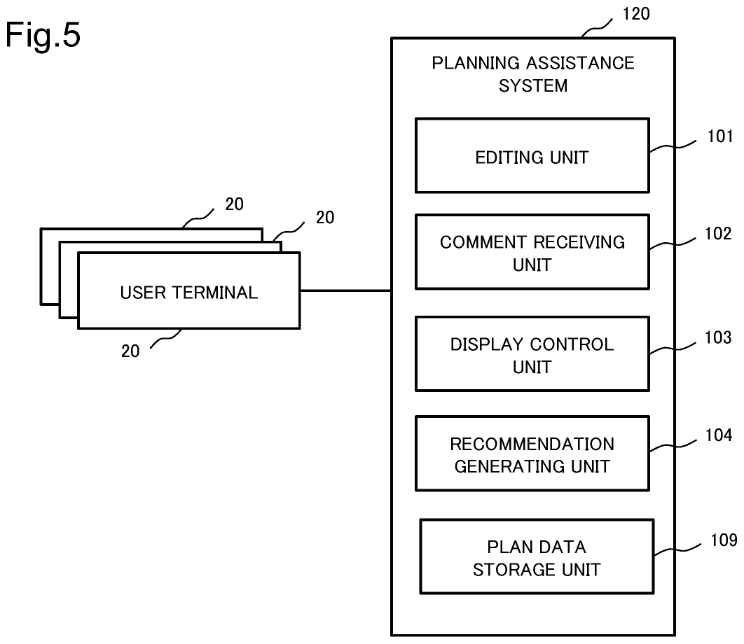

FIG. 5 is a block diagram illustrating a configuration of a planning assistance system 120 according to a second example embodiment. The planning assistance system 120 is different from the planning assistance system 110 according to the first example embodiment in including a recommendation generating unit 104. In the second example embodiment, components similar to those of the first example embodiment are denoted by the same reference numerals, and the description thereof will be omitted.

The recommendation generating unit 104 generates recommendation information related to comments of users. The recommendation generating unit 104 may further generate recommendation information related to a comment with reference to the content of the event related to the comment.

The recommendation information may provide, for example, promotion information related to a comment or an event. The promotion information is, for example, information regarding a product sold at a visiting place registered as an event, a service to be provided, a spot (place) in the visiting place, or a place near the visiting place. The recommendation generating unit 104 may generate the recommendation information based on a keyword included in the event and a keyword included in the comment.

The recommendation information may propose editing of the event. Specifically, for example, addition or deletion of the event, editing of the execution time of the event, or switching of the order of the events is proposed.

The display control unit 103 causes each user terminal 20 to display the recommendation information generated by the recommendation generating unit 104. The display control unit 103 may cause the recommendation information to be displayed only on the manager terminal 20A. Alternatively, the display control unit 103 may cause the promotion information among the recommendation information to be displayed on all the user terminals 20 sharing the plan. The display control unit 103 may cause the editing proposal in the recommendation information to be displayed only on the manager terminal 20A.

The display control unit 103 may cause the recommendation information to be displayed in association with the event.

The processing unit of the user terminal 20 causes the recommendation information generated relating to the comment on the event to be displayed in association with the event, for example, according to the control of the display control unit 103. Further, the processing unit may cause products, services, places, and the like that are promotion information to be displayed selectively. The processing unit may transmit a registration request to the planning assistance system 110 so as to add the purchase of the selected product, the enjoyment of the service, and the visit to the place to the event. In this case, the promotion information proposes editing of the event.

(Operation)

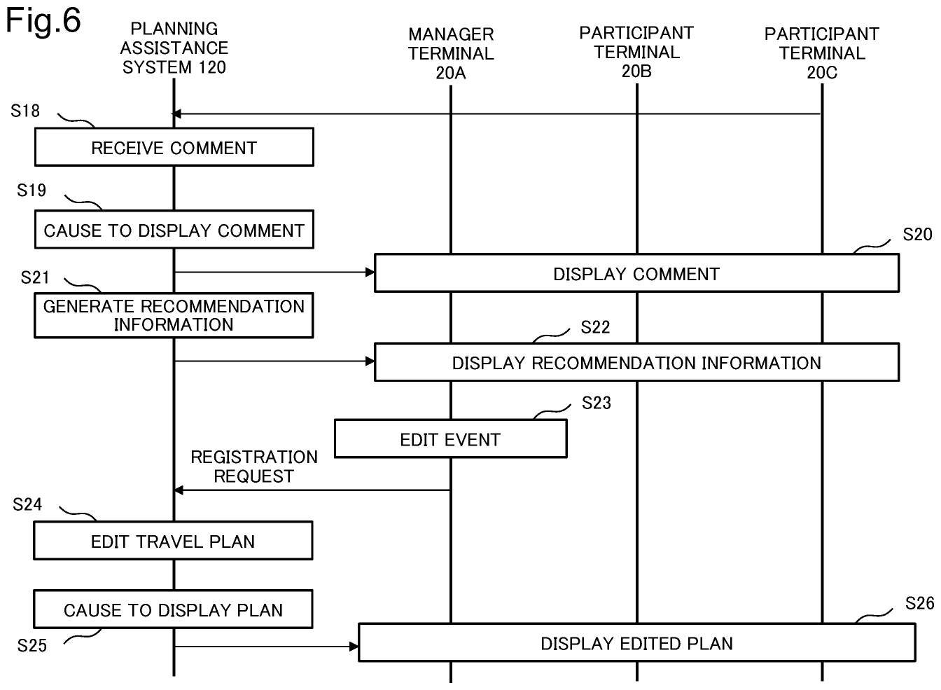

Since operations of the planning assistance system 120 and the user terminal 20 according to the second example embodiment are basically similar to the operations of the planning assistance system 110 and the user terminal 20 according to the first example embodiment illustrated in FIG. 2, the description thereof will be partially omitted. FIG. 6 is a sequence diagram illustrating an operation example of the planning assistance system 120 according to the second example embodiment.

As in the first example embodiment, the comment receiving unit 102 receives a comment (step S18). The display control unit 103 causes each user terminal 20 to display a comment (step S19). The processing unit of the user terminal 20 causes the comment to be displayed (step S20).

Further, the recommendation generating unit 104 generates recommendation information based on the comment (step S21). The display control unit 103 further cause the recommendation information to be displayed on the user terminal 20 (step S22). Steps S19 and S20 may be executed after step S21. Step S20 may be executed simultaneously with step S22.

For example, the manager terminal 20A receives editing of the event (step S23). The manager terminal 20A transmits a registration request of the edited event to the planning assistance system 120 based on the input. The editing unit 101 of the planning assistance system 120 edits the travel plan based on the registration request (step S24). The display control unit 103 of the planning assistance system 120 causes the user terminal 20 to display the edited plan (step S25). Each user terminal 20 displays the edited plan received from the planning assistance system 120 (step S26).

<Display of Comment>

Hereinafter, a specific example of the screen displayed on the user terminal 20 will be described using display on the smartphone as an example.

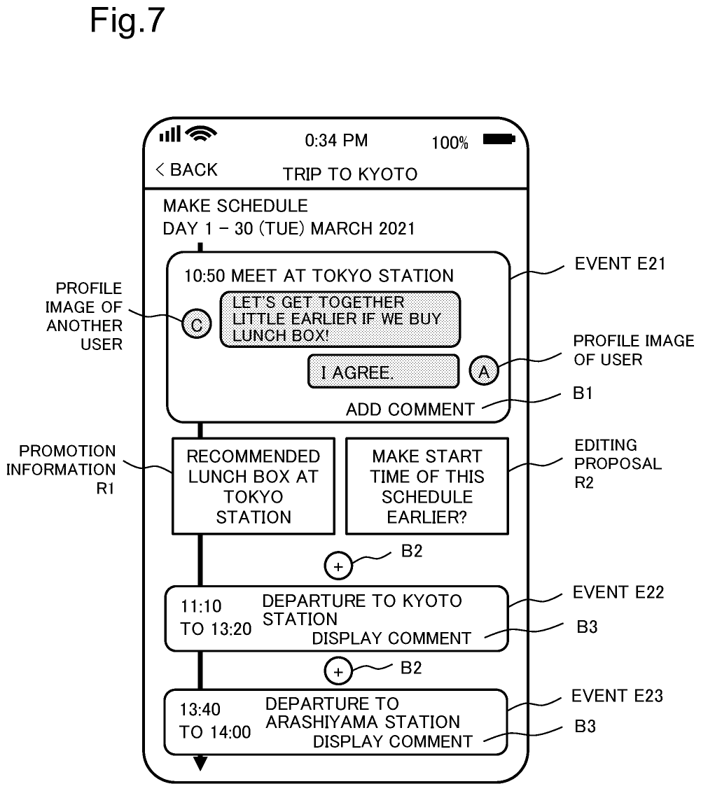

FIG. 7 is a diagram illustrating another example of a display screen of a travel plan displayed on the manager terminal 20A of the manager A. In FIG. 7, an add comment button B1 is displayed as an event E21. The processing unit of the user terminal may cause a comment entry field to be displayed when the add comment button B1 is tapped.

In FIG. 7, the participant C and the manager A make comments on the event E21. For example, the profile image of the user (the manager A in the manager terminal 20A) may be displayed on the right side of the screen. The profile image of another user may be displayed on the left side.

<Display of Promotion Information>

In FIG. 7, an event E21 is scheduled to meet at Tokyo station. In response to this event, the participant C comments “Let's get together earlier if we buy a lunch box!”. The recommendation generating unit 104 generates promotion information based on, for example, a keyword “Tokyo Station” included in the event and a keyword “lunch box” included in the comment. For example, the recommendation generating unit 104 refers to, for example, a server which is not illustrated, and generates information on a lunch box to be sold at Tokyo station. The display control unit 103 causes the generated promotion information R1 to be displayed on the user terminal 20 in association with the event E21. The processing unit of the user terminal 20 may cause more detailed promotion information to be displayed when an area of “recommended lunch box at Tokyo Station” of R1 in FIG. 7 is tapped.

<Display of Edit Proposal>

The recommendation generating unit 104 generates an editing proposal for advancing the start time of the event based on, for example, a keyword “little earlier” or the like. The display control unit 103 causes the generated editing proposal R2 to be displayed in association with the event E21. The display control unit 103 may cause the editing proposal to be displayed only on the manager terminal 20A. The processing unit of the user terminal 20 may cause editing options such as “advance by 10 minutes” and “advance by 20 minutes” to be displayed selectively when the area of “make start time of this schedule earlier?” of the editing proposal R2 in FIG. 7 is tapped. In a case where “advance by 20 minutes” is selected, the processing unit of the user terminal 20 transmits a registration request for editing the event E21 to the planning assistance system 120.

The recommendation generating unit 104 may generate an editing proposal for adding a shopping event based on, for example, a keyword “Tokyo Station” included in the event and a keyword “buy” included in the comment, or the like. The display control unit 103 may cause the user terminal 20 to display an area of “add a shopping schedule at Tokyo Station?” or the like instead of the editing proposal R2 in FIG. 7 based on the editing proposal generated by the recommendation generating unit 104. When the area is tapped, the processing unit of the user terminal transmits a registration request of an event to be added to the planning assistance system 120.

The event may be editable by tapping each event. Further, an event may be added when an add event button B2 is tapped. However, since the editing options are displayed from the display of the editing proposal R2, the manager can easily add and edit the event. The execution time of another event may be adjusted by the editing unit 101 by adding the event.

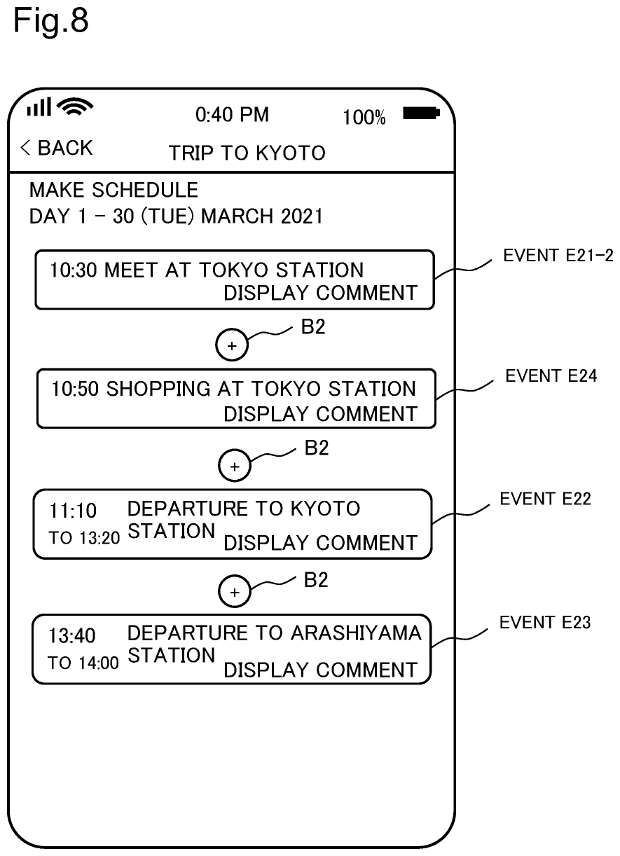

FIG. 8 is a diagram illustrating an example of a display screen of a travel plan displayed on the user terminal 20 in a case where the plan of FIG. 7 is edited. In FIG. 8, the start time of the event E21-2 is set to a time earlier than the start time of the event E21 in FIG. 7. In FIG. 8, an event E24 is added.

<Stop of Display of Comment and Recommendation Information>

In FIG. 7, the display of a comment may be stopped by any method by processing of the display control unit 103 or the processing unit of the user terminal 20. The comment whose display has been stopped may be displayed again, for example, by tapping a display comment button B3.

After the event is edited based on the recommendation information, display of the comment referred to by the recommendation generating unit 104 may be stopped by the display control unit 103. For example, after the start time of the event E21 is changed, the display of the comment of the participant C illustrated in FIG. 7 may be stopped. After the event is edited based on the recommendation information, the display control unit 103 may request the manager to input a range of comments to be deleted. In this case, the display control unit 103 may delete the comment based on the input by the manager.

Further, the display of each piece of recommendation information (the promotion information R1 or the editing proposal R2) in FIG. 7 may be stopped by tapping the event E21.

Further, the display control unit 103 or the processing unit of the user terminal 20 may execute processing of stopping the display of the comment when the travel plan is executed. For example, the display control unit 103 may refer to the current date and time and stop the display of the comment on the execution date or the execution time of the plan. Alternatively, the processing unit may stop the display of the comment in response to an input from the user on the execution date of the plan.

By stopping the display of the comment and the recommendation information, the display control unit 103 can cause the user terminal 20 to display more other events.

### Effects

According to the second example embodiment, convenient information can be provided to users. The reason is that the recommendation generating unit 104 generates the recommendation information related to comments of the users. Another reason is that the display control unit 103 causes the user terminal 20 to display the recommendation information.

### MODIFICATION EXAMPLE

Each of the above-described example embodiments can be modified, for example, as illustrated in the following modifications.

### Modification Example 1

In the first example embodiment, the case where the manager adds an event has been described. In each example embodiment, the editing unit 101 may receive selection of a model course including a plurality of preset events from the manager terminal 20A and register the events included in the model course. Further, the editing unit 101 may automatically register the event based on the matching score of the user of each spot calculated by any method. For example, the editing unit 101 may register a plurality of events so as to go around many spots having high conformity scores in view of a spot-specific tourist time, a time taken to move to another spot, and the like, using an existing technique.

### Modification Example 2

One of the managers among the users sharing the itinerary may be an automated bot. The automated bot edits the travel plan while consulting with one or more other users (other managers or general participants). The automated bot may receive, from another user, a request for the travel, such as an itinerary, means of movement, area, or theme, using an existing technique, and add an event. The plan with the added event is shared between the automated bot and one or more other users. The automated bot may edit the event based on comments on the event of other users.

### Modification Example 3

In the travel plan, an open range and a password may be set. The planning assistance systems 110 and 120 may cooperate with a social network service (SNS). The manager terminal 20A may select a participant of a travel to share a plan from connections on the SNS of the manager. The planning assistance systems 110 and 110 may transmit a link for accessing the plan to the contact address of the SNS of the participant based on the selection of the manager terminal 20A. The user who wishes to view the itinerary may register to a service provided by the planning assistance systems 110 and 110. The manager may select a user who publishes the plan from among the registered users.

### Modification Example 4

The comment receiving unit 102 may receive a reaction of another user to the comment. The form of the reaction of another user is not particularly limited. In FIG. 7, the comment of the manager A “yes” received after the comment of the participant C is an example of the reaction of a user. The comment receiving unit 102 may determine whether the reaction of a user is positive or negative by using an existing technique. For example, the comment receiving unit 102 makes a determination with reference to a dictionary storing examples of reactions to comments. The comment receiving unit 102 may aggregate whether there are many positive reactions or many negative reactions, and determine a total reaction of users. The comment receiving unit 102 may transmit the determination result to the recommendation generating unit 104.

The recommendation generating unit 104 may generate the recommendation information related to a reaction of a user received for the comment. For example, in a case where a reaction of another user to a certain comment is positive, the recommendation generating unit 104 generates the recommendation information based on the comment. In a case where the reaction of the another user is negative, for example, the recommendation generating unit 104 does not generate the recommendation information based on the comment.

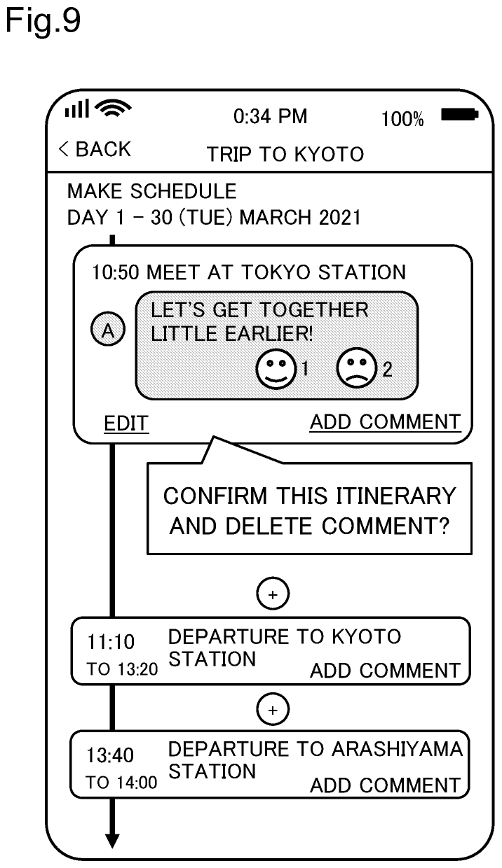

The reaction of a user may be received in the form of pictograph. The pictograph is, for example, a smiling face, a sad face, a heart shape, a picture with a thumb's up, or the like. FIG. 9 is a diagram illustrating a display screen of another example of the reaction of the user to the comment. For example, the user selects a displayed pictograph and inputs a reaction. When the reaction to the comment is received by a pictograph, the reaction can be made faster than returning the comment by text.

In FIG. 9, it is displayed that one user has selected a smiling face and two users have selected a sad face. Since there are more sad faces, the comment receiving unit 102 may determine that the reaction is negative. In a case where reactions of other users are negative, the display control unit 103 may propose deletion of the comment to the manager.

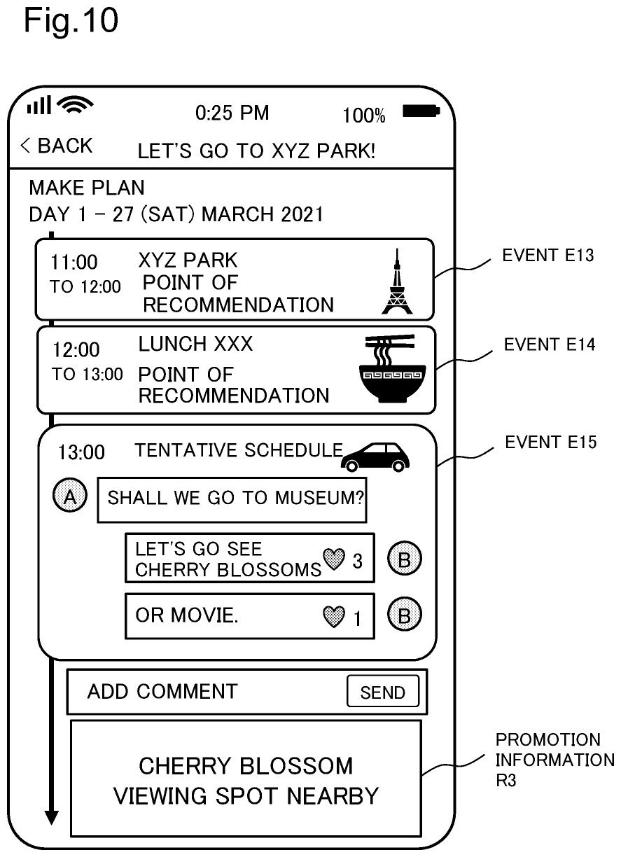

FIG. 10 is a diagram illustrating a display screen of another example of the reaction of the user to the comment. In response to the event E15, user A proposes to go to a museum. User B proposes to go to see cherry blossoms with the first comment, and proposes to go to see a movie with the second comment. The comment receiving unit 102 may count the number of heart-shaped pictographs and determine that the first comment of B has the most positive reactions.

The recommendation generating unit 104 may generate the recommendation information based on a comment having the most positive reaction among a plurality of comments for one event. For example, in FIG. 10, the recommendation generating unit 104 generates promotion information regarding a cherry blossom viewing spot near the visiting place of a preceding or following event. The display control unit 103 causes the user terminal 20 to display the promotion information R3 in FIG. 10 below the event E15. The recommendation generating unit 104 may generate the recommendation information for proposing editing instead of the promotion information. For example, in FIG. 10, the recommendation generating unit 104 generates a proposal for changing the “tentative plan” to “cherry blossom viewing”.

### Third Example Embodiment

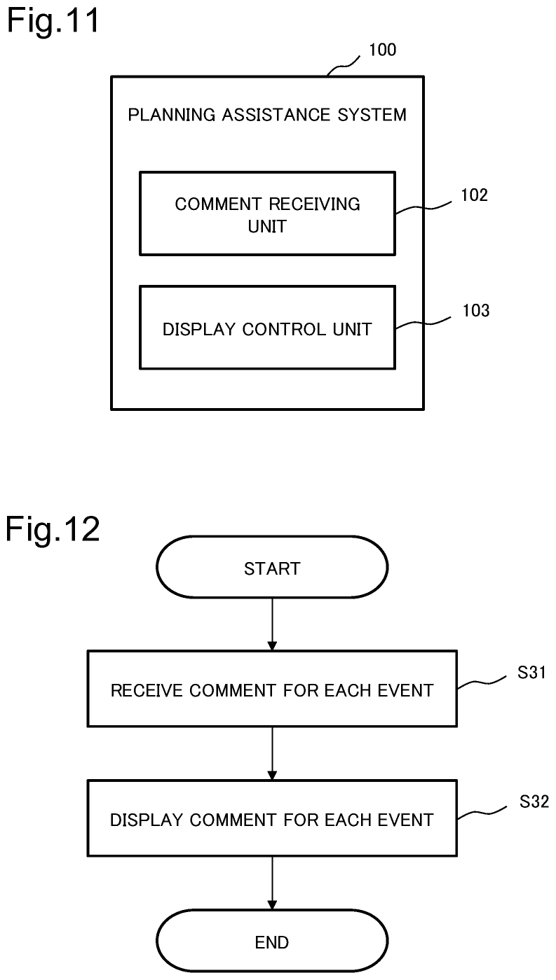

Next, as a basic configuration of the planning assistance system 110 according to the first example embodiment and the planning assistance system 120 according to the second example embodiment, a configuration of a planning assistance system 100 will be described. FIG. 11 is a block diagram illustrating a configuration of the planning assistance system 100 according to a third example embodiment.

The planning assistance system 100 includes a comment receiving unit 102 and a display control unit 103.

The comment receiving unit 102 receives a comment of each user for each of a plurality of events included in the travel plan.

The display control unit 103 causes one or more of any display means to display the received comment in association with each event. The display means is, for example, a display included in the planning assistance system 100 or a display communicably connected to the planning assistance system 100 in a wired or wireless manner. The display means may be a user terminal communicably connected via a communication network or a display connected to the user terminal.

FIG. 12 is a flowchart illustrating an operation example of the planning assistance system 100 according to the third example embodiment. The comment receiving unit 102 receives a user's comment for each event included in the travel plan (step S31). The display control unit 103 causes the received comment to be displayed in association with each event (step S32).

According to the third example embodiment, in a case where a plurality of users edits a travel plan including a plurality of events while consulting with each other, each user can easily comment on each of the events.

[Hardware Configuration]

In each of the example embodiments described above, each component of the planning assistance systems 100, 110, and 120 indicates a block of functional units. Some or all of the components of each device may be achieved by any combination of a computer 500 and a program.

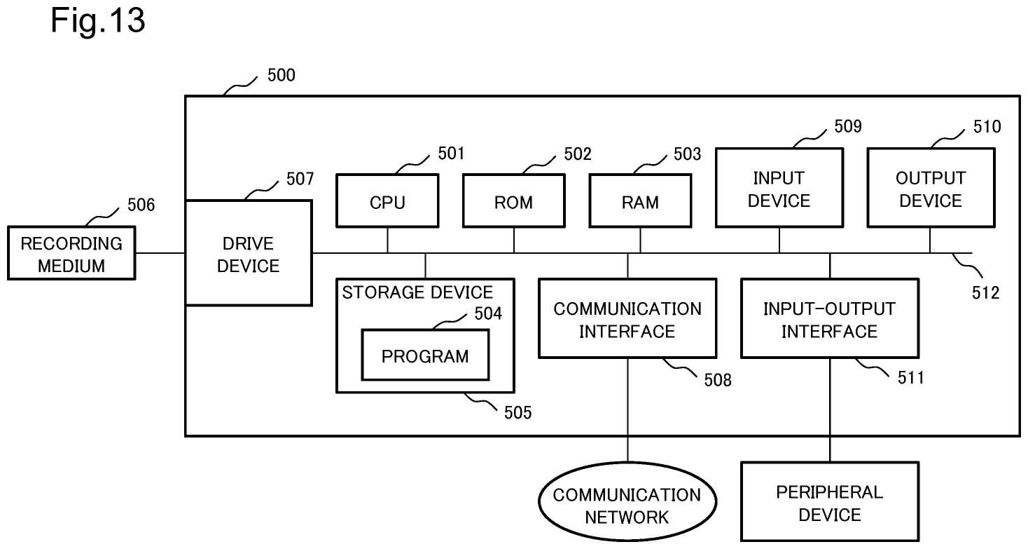

FIG. 13 is a block diagram illustrating an example of a hardware configuration of the computer 500. Referring to FIG. 13, the computer 500 includes, for example, a central processing unit (CPU) 501, a read only memory (ROM) 502, a random access memory (RAM) 503, a program 504, a storage device 505, a drive device 507, a communication interface 508, and a bus 512.

The program 504 includes instructions for achieving the functions of each device. The program 504 is stored in advance in the ROM 502, the RAM 503, and/or the storage device 505. The CPU 501 achieves the functions of each device by executing instructions included in the program 504. For example, the CPU 501 of the planning assistance system 110 executes instructions included in the program 504 to implement the functions of the planning assistance system 110. The RAM 503 may store data to be processed in the functions of each device. For example, events and comments in the planning assistance system 110 may be stored in the RAM 503 of the computer 500.

The drive device 507 reads and/or writes on the recording medium 506. The communication interface 508 provides an interface with a communication network. The input device 509 is, for example, a mouse, a keyboard, or the like, and receives an input of information from a user who operates the planning assistance system 100. The output device 510 is, for example, a display, and outputs (displays) information to the user. The input-output interface 511 provides an interface with a peripheral device. The bus 512 connects these hardware components. The program 504 may be supplied to the CPU 501 via a communication network, or may be stored in the recording medium 506 in advance, read by the drive device 507, and supplied to the CPU 501.

The hardware configuration illustrated in FIG. 13 is an example, and other components may be added or some of the components are not necessary to be included.

There are various modification examples of the implementation method of each device. For example, each device (planning assistance systems 100, 110, 120) may be achieved by any combination of a computer and a program different for each component. A plurality of components included in each device may be achieved by any combination of one computer and a program. Each of the planning assistance systems 100, 110, and 120 is an example embodiment of an information processing apparatus.

Some or all of the components of each device may be achieved by general-purpose or dedicated circuitry including a processor or the like, or a combination thereof. These circuits may be configured by a single chip or may be configured by a plurality of chips connected via a bus. Some or all of the components of each device may be achieved by a combination of the above-described circuit or the like and a program.

When some or all of the components of each device is achieved by a plurality of computers, circuits, and the like, the plurality of computers, circuits, and the like may be arranged in a centralized manner or in a distributed manner.

At least a part of the planning assistance systems 100, 110, and 120 may be provided in a software as a service (SaaS) format. That is, at least a part of the functions for achieving the planning assistance systems 100, 110, and 120 may be executed by software executed via a network.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. The configurations according to the example embodiments can be combined with each other without departing from the scope of the present disclosure.

Some or all of the example embodiments described above may also be described as in the following supplementary notes, but are not limited to the following.

### SUPPLEMENTARY NOTE 1

A planning assistance system, including:
a comment reception means that receives a comment of each of users for each of a plurality of events included in a travel plan; and
a display control means that causes a display means to display the received comment in association with each of the events.

### SUPPLEMENTARY NOTE 2

The planning assistance system according to Supplementary Note 1, in which
the events include one or more of a movement during a travel, a visit to a place, and an experience, and
the display control means causes the comment to be displayed in association with the events.

### SUPPLEMENTARY NOTE 3

The planning assistance system according to SUPPLEMENTARY NOTE 1 or 2, in which
the display control means causes any one of a start time, an end time, and a duration of each of the events to be displayed in association with each of the events and the comment.

### SUPPLEMENTARY NOTE 4

The planning assistance system according to any one of Supplementary Notes 1 to 3, further including a recommendation generating means that generates recommendation information related to the comment.

### SUPPLEMENTARY NOTE 5

The planning assistance system according to Supplementary Note 4, in which
the recommendation generating means generates promotion information related to the comment, the promotion information being the recommendation information regarding a product, a service, or a place.

### SUPPLEMENTARY NOTE 6

The planning assistance system according to SUPPLEMENTARY NOTE 4 or 5, in which
the recommendation generating means generates the recommendation information that proposes editing of the events related to the comment.

### SUPPLEMENTARY NOTE 7

The planning assistance system according to Supplementary Note 6, in which
the display control means stops display of the comment when the events are edited based on the recommendation information.

### SUPPLEMENTARY NOTE 8

The planning assistance system according to any one of Supplementary Notes 4 to 7, in which
the recommendation generating means further generates recommendation information related to a reaction of the users received for the comment.

### SUPPLEMENTARY NOTE 9

A planning assistance method, including:
receiving a comment of each of users for each of a plurality of events included in a travel plan; and
causing a display means to display the received comment in association with each of the events.

### SUPPLEMENTARY NOTE 10

A recording medium that non-transiently records a planning assistance program for causing a computer to execute:
a process of receiving a comment of each of users for each of a plurality of events included in a travel plan; and
a process of causing a display means to display the received comment in association with each of the events.

### SUPPLEMENTARY NOTE 11

A recording medium that non-transiently records a program for causing a computer to execute:
a process of receiving a comment of each of users from an information processing apparatus that receives the comment of each of users for each of a plurality of events included in a travel plan and associates the received comment with each of the events;
a process of displaying the travel plan; and
a process of transmitting comments of the users input for the event in the user terminal to the information processing device.

### SUPPLEMENTARY NOTE 12

The recording medium that non-transiently records the program according to SUPPLEMENTARY NOTE 11, further causing the user terminal to execute:
processing of displaying the travel plan and the comment on each of the events on a same screen.

### SUPPLEMENTARY NOTE 13

The recording medium that non-transiently records the program according to SUPPLEMENTARY NOTE 11 or 12, further causing the user terminal to execute:
processing of controlling display and non-display of the comment in response to an input of the user.

### SUPPLEMENTARY NOTE 14

The recording medium that non-transiently records the program according to any one of Supplementary Notes 11 to 13, further causing the user terminal to execute:
processing of displaying recommendation information generated relating to a comment on the event in association with the event.

### REFERENCE SIGNS LIST

100, 110, 120 planning assistance system
101 editing unit
102 comment receiving unit
103 display control unit
104 recommendation generating unit
109 plan data storage unit
20 user terminal

What is claimed is:

1. A planning assistance system, comprising:
at least one memory configured to store instructions; and
at least one processor configured to execute the instructions to:
receive a comment of each of users for each of a plurality of events included in a travel plan; and
cause a display to display the received comment in association with each of the events.

2. The planning assistance system according to claim 1, wherein
the events include one or more of a movement during a travel, a visit to a place, and an experience.

3. The planning assistance system according to claim 1, wherein the at least one processor is further configured to execute the instructions to:
cause any one of a start time, an end time, and a duration of each of the events to be displayed in association with each of the events and the comment.

4. The planning assistance system according to claim 1, wherein the at least one processor is further configured to execute the instructions to:
generate recommendation information related to the comment.

5. The planning assistance system according to claim 4, wherein the at least one processor is further configured to execute the instructions to:
generate promotion information related to the comment, the promotion information being the recommendation information regarding a product, a service, or a place.

6. The planning assistance system according to claim 4, wherein the at least one processor is further configured to execute the instructions to:
generate the recommendation information that proposes editing of the events related to the comment.

7. The planning assistance system according to claim 6, wherein the at least one processor is further configured to execute the instructions to:
stop display of the comment when the events are edited based on the recommendation information.

8. The planning assistance system according to claim 4, wherein the at least one processor is further configured to execute the instructions to:
generate recommendation information related to a reaction of the users received for the comment.

9. A planning assistance method, comprising:
receiving a comment of each of users for each of a plurality of events included in a travel plan; and
causing a display to display the received comment in association with each of the events.

10. A recording medium that non-transiently records a planning assistance program for causing a computer to execute processing comprising:
receiving a comment of each of users for each of a plurality of events included in a travel plan; and
causing a display to display the received comment in association with each of the events.

11-14. (canceled)
